(19) United States
(12) Patent Application Publication
(10) Pub. No.: US 2010/0251859 A1
(43) Pub. Date: Oct. 7, 2010

(54) Universal Pawl Component for Open-ended Ratchet Wrench

(76) Inventors: Steven Gapp, Dousman, WI (US); Clint Johnson, Dousman, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/419,791

(22) Filed: Apr. 7, 2009

(51) Int. Cl. B25B 13/46

(52) U.S. Cl. 81/63; 81/61

(57) ABSTRACT

The present invention relates to the field of open-ended wrenches, and more specifically to a pawl component which can be used within ratchet wrench housings having conventional dimensions to create an inexpensive open-ended ratchet wrench which can be easily mass-produced.

### FIELD OF INVENTION

The present invention relates to the field of open-ended wrenches, and more specifically to a pawl component which can be used to manufacture an inexpensive open-ended ratchet wrench which can be easily mass-produced.

### BRIEF DESCRIPTION OF THE DRAWINGS

FIG. 1 illustrates a sectional view of an exemplary embodiment of an open-ended ratchet wrench.

FIG. 2 illustrates a sectional view of an exemplary embodiment of an open-ended ratchet wrench in the open position.

FIG. 3 illustrates a sectional view of an alternate embodiment of an open-ended ratchet wrench.

FIG. 4 illustrates a sectional view of an alternate embodiment of an open-ended ratchet wrench.

### GLOSSARY

As used herein, the term “pawl” or “pawl component” means a movable component which operates as a lever and which includes protuberances which engage a ratchet. In various embodiments, the pawl may control the direction of the ratchet (e.g., when the wrench rotates one way, the pawl slides over the teeth; when the wrench rotates the other way, the pawl catches in the teeth). In various embodiments, bolt engaging components may be used to apply pressure to a pawl (e.g., a spring loaded component) to keep a pawl engaged within the teeth of a ratchet. A pawl may be machined, stamped or molded and constructed of one or more components having singular or multiple protuberances.

As used herein, the term “universal pawl component” means a component which may be used to create an open-ended ratchet wrench using tooling and wrench components known in the art.

As used herein, the term “spring assembly” means an apparatus used to apply pressure to a pawl so that pawl surface or protuberances of the pawl engage with the ratchet.

As used herein, the term “ratchet” or “gear wheel” means a wheel that has teeth, which may be curved or contoured to facilitate engagement by a pawl. The motion created by a ratchet may be continuous or intermittent.

As used herein “tooth” or “teeth” means protrusions of a ratchet which may or may not be curved or contoured.

As used herein, the term “ratchet engaging teeth” means a structural component of a pawl, which may be of varying sizes and configurations, used to engage the teeth of a ratchet.

As used herein, the term “protuberance” means a structural component inserted through an aperture which allows another element to pivot. The protuberance may be a pin, a bolt, a threaded rod, a rivet and a roll pin, or any other structural component known in the art.

As used herein, the term “pivot” means to rotate or turn a component around a fixed point.

As used herein, the term “threaded rod” means any component over which a bolt is turned, and may include a rod which is attached at one or both ends to another structure, and which may be solid, hollow and/or difficult to access because of its placement within a structure.

As used herein, the term “racket wrench housing” means a component which has wrench head for receiving a ratchet wheel and pawl.

As used herein, the term “wrench head” means a component designed to receive a ratchet wheel and pawl component.

As used herein, the term “chamfered” means beveled, contoured or smoothed to accommodate rotation.

### BACKGROUND

A ratchet wrench is a type of wrench having ends that surround the nut or head of a bolt. The wrench provides a mechanical advantage by applying torque to turn bolts, nuts or other items designed to interface with a wrench. The ratcheting mechanism allows the nut or bolt to be tightened or loosened with a reciprocating motion, without requiring that the wrench be removed and refitted after each turn.

A ratchet wrench includes ratchet and pawl components known in the mechanical arts to control and secure movement. Ratchets consist of a ratchet wheel, and may include a spring assembly which applies pressure to a pivoting spring loaded finger called a pawl that engages the teeth. Either the teeth, or the pawl, are slanted at an angle, so that when the teeth are moving in one direction, the pawl slides up and over each tooth in turn, with the spring forcing it back with a ‘click’ into the depression before the next tooth. When the teeth are moving in the other direction, the angle of the pawl causes it to catch against a tooth and stop further motion in that direction.

Generally, a ratchet wheel is similar to other types of gear wheels, except that its teeth or cogs may be cut with a sloped side and a “straight” or “offcut” side. That is in contrast to the two sloped sides of the tooth or cog on a regular gear wheel. Additionally, there is usually a curve in the slope of the “regular” side that acts as a ramp for the pawl to ride on. The pawl, which is usually spring loaded to keep it engaged with the teeth, will, when the ratchet wheel is rotated in one direction, slide up or “climb” the slanted or sloped side of a tooth. The pawl will then “jump” down into the bottom of the tooth space after going over the tip of the tooth, and the spring will have pushed it there. It will then ride up the next slope on the next tooth as the ratchet wheel moves in the same “forward” direction. But if the ratchet wheel is rotated in a “backward” direction, the pawl will only allow movement until it comes in contact with the “straight” side of the next tooth back, and it will jam there. This will limit backward movement of the ratchet wheel to a tooth length and no more, as long as the pawl is acting normally to check the backward rotation.

Reversible ratchet wrenches are also known in the art. A reversible ratchet wrench has a handle portion and a head portion. The head portion includes a drive member having teeth thereon and a pawl having teeth which selectively engage the teeth on the drive member. The head portion has two partially overlapping cavities formed therein, the cavities being formed from the bottom of the head portion. The top of the head portion has two spaced-apart openings formed therein, each opening communicating respectively with one of the two cavities. The drive member is disposed in the larger cavity and the pawl is disposed in the smaller cavity. A one-piece lever is provided having a non-cylindrical stem depending there from. The stem is received in a cooperating bore in the pawl. A multi-sided shelf is formed on the stem, the shelf being received in a cooperating cavity in the top of the pawl. The top of the head portion of the wrench is received between the top portion of the lever means and the shelf on the stem. The larger cavity further has an inner annular groove formed near the bottom surface of the head portion. A retaining member having two circular portions is provided. The one circular portion may be received in the annular groove and the other portion is disposed in the smaller circular cavity to retain the pawl and the drive member in the head portion of the wrench. The retaining member may be removed for replacement and/or repair of the drive member and the pawl.

Various attempts are known in the art to create an open-ended ratchet wrench. However, traditionally these open-ended ratchet wrenches are expensive to produce. The wrenches often require extensive and expensive milling operations to provide spaces in the head of the wrench for the driving means, the pawl, springs and other components. Substantial modifications have been required to be made to existing wrench bodies, and complex specialized parts have been required. Additionally, most pawl components used to create an open-ended ratchet wrench include a plurality of small parts which are labor intensive to assemble. The configuration and interrelation of the components, in many instances, requires a comparatively long time to assemble, and the complexity of the parts makes error-free design and reliable operation of the tool more difficult.

A problem generally known in the art with box type wrenches using ratchet and pawl systems is that the head of the wrench is generally closed, and threaded components (such as brake lines) must be disassembled to allow the wrench to fit over them.

Many attempts have been made in the art to design an open-ended box wrench using a ratchet and pawl system and to simplify the components. However, these solutions require specially machined parts and pawl components that must be assembled from multiple parts (i.e., pawl assemblies). This places the product out of the financial reach of consumers who only occasionally require the use of a tool to repair vehicle brake lines, work with rusted components, and use a wrench on mechanical components that are otherwise difficult to access with a standard ratcheted closed-end box wrench.

It is desirable to introduce an open-ended box wrench using a ratchet and pawl system which can be affordably manufactured and mass produced, and which does not require specialized parts or multi-component pawl assemblies.

It is also desirable to have a single-piece pawl component which can be easily stamped, molded or machined with a minimum of error, calibration and cost.

### SUMMARY OF THE INVENTION

There exists a need for a ratchet wrench and universal pawl component to create an open-ended ratchet wrench which has comparatively few separate parts, in which the need for expensive and extensive tooling is significantly reduced, which can be assembled easily and rapidly by relatively unskilled labor, and in which repairs and replacement parts are easily accomplished and obtained. The use of a universal pawl component should also result in a wrench design which permits changes for different market segments.

The present invention utilizes a universal pawl component comprised of a contoured metal piece,.said metal piece having at least two ratchet engaging teeth, wherein at one of said ratchet engaging teeth are spaced so that at least one of the ratchet engaging teeth is engaged with an open-ended ratchet at all times.

### DETAILED DESCRIPTION OF INVENTION

For the purpose of promoting an understanding of the present invention, references are made in the text to exemplary embodiments of a simplified open-ended ratchet wrench with single pawl mechanism only some of which are described herein. It should be understood that no limitations on the scope of the invention are intended by describing these exemplary embodiments. One of ordinary skill in the art will readily appreciate that alternate but functionally equivalent simplified open-ended ratchet wrenches with single pawl mechanisms may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related. For example, a simplified open-ended ratchet wrench with single pawl mechanism may use two identical pawl mechanisms or may use a single pawl component to engage opposite sides of the ratchet component.

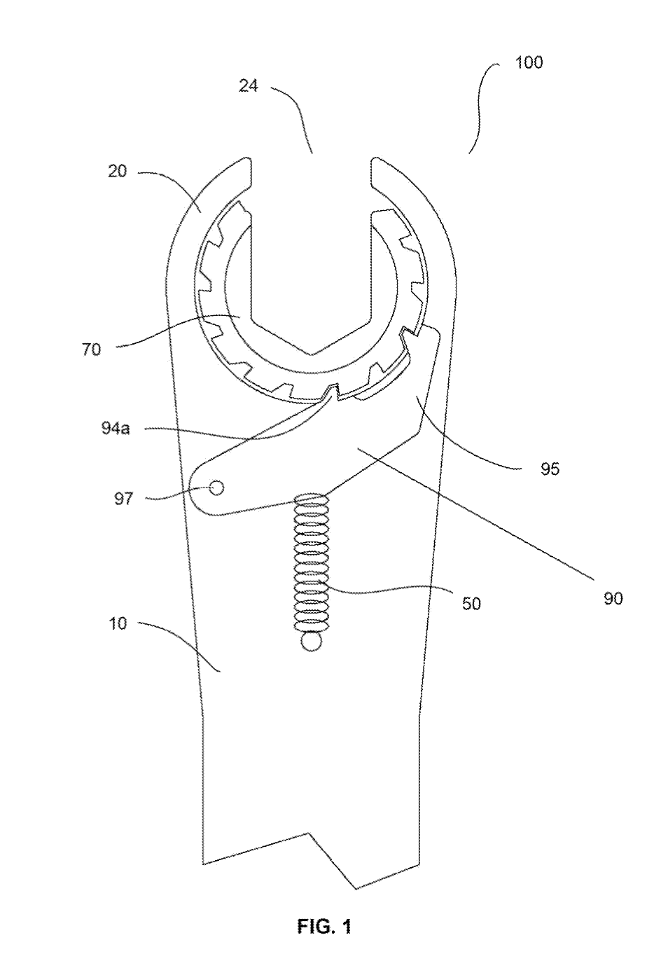

FIG. 1 is sectional view of an exemplary embodiment of open-ended ratchet wrench 100 in the open position which includes ratchet wrench housing 10, with an open-ended wrench head 20, which includes head opening 24, and ratchet 70. The embodiment shown further includes spring assembly 50.

FIG. 1 further illustrates an exemplary embodiment of universal pawl component 90 which further includes contoured metal piece 95 having an aperture 97 through which a protuberance is inserted to allow universal pawl component to pivot freely at a rotation of 1 to 90 degrees. In the embodiment shown, single pawl component is a curved component having at least two pawl teeth, 94a and 94b. In other embodiments, pawl component 90 may have fewer or more pawl teeth, which engage ratchet 70 to control the movement of ratchet 70. In the embodiment shown aperture 97 is placed off-center within contoured metal piece 95, but in other embodiments, aperture 97 may centered or in any other position on contoured metal piece 95 or ratchet wrench housing 10.

In the embodiment shown, contoured metal piece 95 is a singly machined or tooled piece which includes pawl teeth 94a and 94b and is contoured to fit within ratchet wrench housing 10, and includes at least two pawl teeth. Other embodiments may include fewer or more teeth. One skilled in the art will recognize that singly molded pawl component may be machined, molded or stamped in a single operations and includes no assembly or calibration of components to securely engage ratchet 70 to at least one point when open-ended ratchet wrench 100 is in the open position. In the embodiment shown, contoured metal piece 95 includes aperture 97 which is used to mount contoured metal piece 95 and on which contoured metal piece 95 pivots so at least one of pawl teeth 94a and 94b is capable of engaging ratchet 70 at all times regardless of the rotational position of ratchet 70.

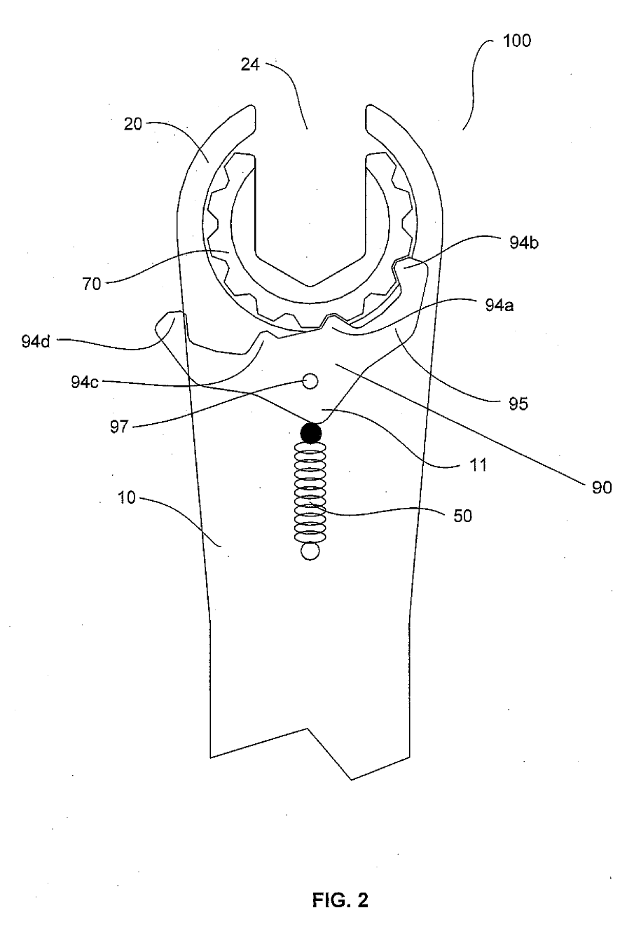

FIG. 2 is a sectional view of an exemplary embodiment of open-ended ratchet wrench 100 in the open position which includes four ratchet teeth 94a, 94b , 94c and 94d. In the embodiment shown ratchet wrench housing 10 includes an open-ended wrench head 20, which includes head opening 24, and ratchet 70. The embodiment shown further includes spring assembly 50.

FIG. 2 further illustrates an exemplary embodiment of universal pawl component 90 which further includes contoured metal piece 95 having an aperture 97 through which a protuberance is inserted to allow universal pawl component to pivot freely at a rotation of 1 to 90 degrees. In the embodiment shown, aperture 97 is centered, and ratchet teeth 94a, 94b , 94c and 94d allow ratchet 70 to be pivotally moved in two directions. In the embodiment shown, ratchet teeth 94b and 94d operate as levers and control the direction of ratchet 70 and protrude externally from ratchet wrench housing 10. In the embodiment shown, universal pawl component 90 further includes base protuberance 11 which provides a point of increased force/tension with spring assembly 50.

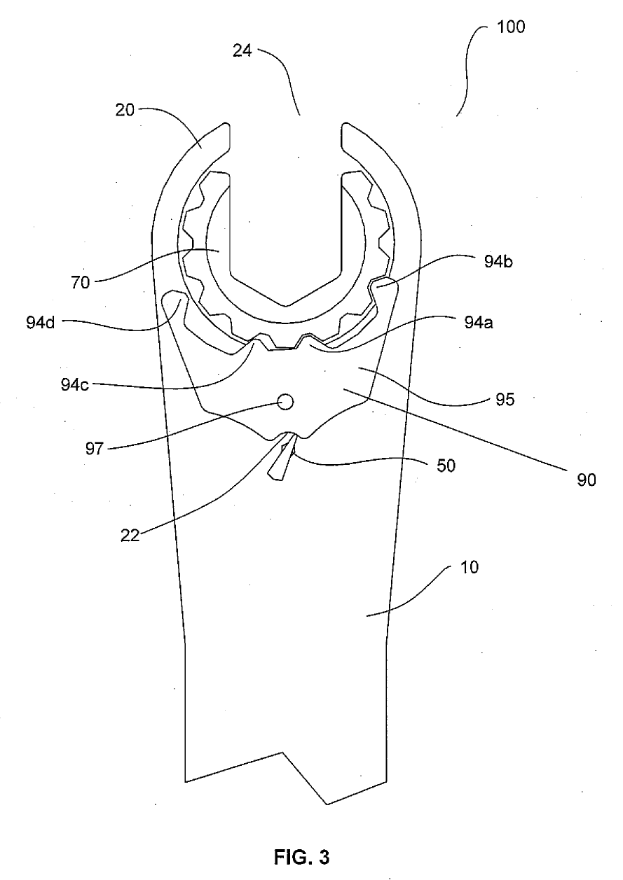

FIG. 3 illustrates an additional exemplary embodiment of open-ended ratchet wrench 100 which includes a plurality of ratchet teeth 94a, 94b , 94c and 94d. Various embodiments of open-ended ratchet wrench 100 may include more, fewer or differently proportioned ratchet teeth. FIG. 3 further illustrates recess 22 to accommodate components of a spring assembly or lever.

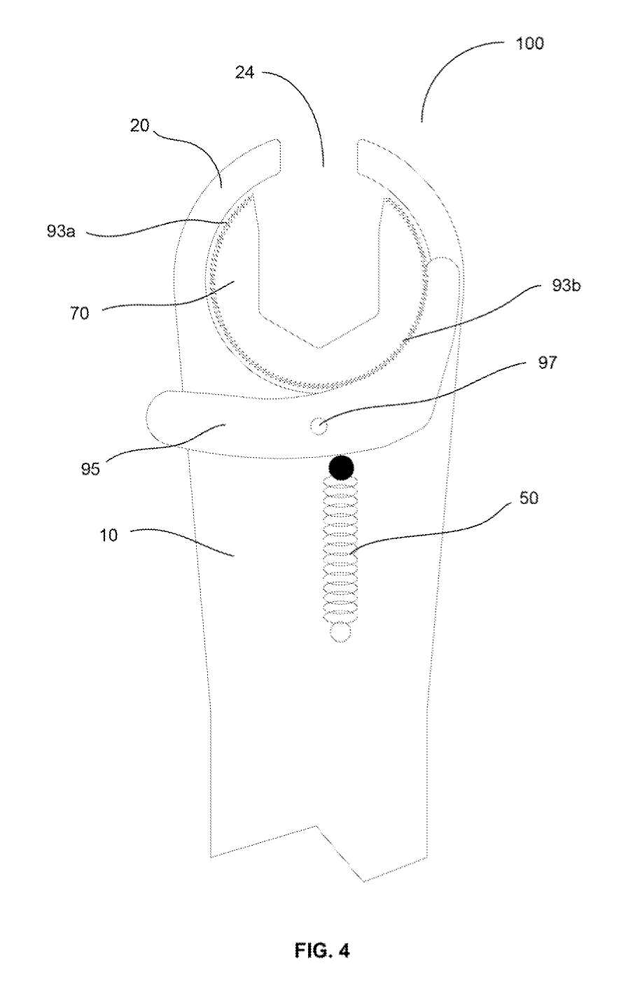

FIG. 4 illustrates an additional exemplary embodiment of open-ended ratchet wrench 100 which includes a plurality of small ratchet teeth 93a on ratchet 70 and a plurality of small ratchet teeth 93b on contoured metal piece 95 to provide multiple points of engagement for smaller turning tolerances.

1. A universal pawl component comprised of:
a contoured metal piece, said metal piece having at least two ratchet engaging teeth, wherein said at least two ratchet engaging teeth are spaced so that at least one of said at least two ratchet engaging teeth is engaged with an open-ended ratchet at all times; and
at least one aperture within said contoured metal piece for pivotally moving said contoured metal piece around a protuberance within ratchet wrench housing, said protuberance structurally engaging said at least one aperture within said contoured metal piece.

2. The universal pawl component of claim 1, being of a sufficient size and curvature so that at least one of said at least two ratchet engaging teeth is engaged with an open-ended ratchet at all times.

3. The universal pawl component of claim 1, which further includes at least one pawl engaging tooth which protrudes from within said open-ended ratchet.

4. The universal pawl component of claim 1, wherein said protuberance is a structural component selected from a group consisting of a pin, a bolt, a threaded rod, a rivet and a roll pin, and said protuberance structurally engages said at least one aperture within said contoured metal piece.

5. The universal pawl component of claim 1, wherein said contoured metal piece has at least four ratchet engaging teeth to facilitate motion of a ratchet in two directions.

6. The universal pawl component of claim 1, which includes multiple ratchet engaging teeth.

7. The universal pawl component of claim 6, wherein said multiple ratchet engaging teeth are of varying sizes.

8. The universal pawl component of claim 1, which further includes a protuberance at its base to engage a spring assembly.

9. The universal pawl component of claim 1, which further includes a recess at its base to accommodate a lever for changing the direction of the pawl.

10. An open-ended ratchet wrench utilizing a universal pawl component comprised of:
a universal pawl component having an aperture;
an open-ended ratchet component having a head opening;
a partially hollow wrench housing;
a spring assembly; and
a protuberance which pivotally engages said aperture of said universal pawl component.

11. The open-ended ratchet wrench of claim 10, wherein said open-ended ratchet wrench further includes at least one smooth edge which engages said wrench housing, and enables said open-ended ratchet component to move slidably within said wrench housing, and said wrench housing is adapted to allow said open-ended ratchet component to rotate within said wrench housing.

12. The open-ended ratchet wrench of claim 10, wherein said wrench housing further includes chamfered edges to accommodate said head opening in said open ended ratchet component and to facilitate uninterrupted rotation.

13. The open-ended ratchet wrench of claim 10, wherein said wrench housing is partially hollow to accommodate said open-ended ratchet component, said universal pawl component, said spring assembly and a pivoting protuberance on which said universal pawl component pivotally moves.

14. The open-ended ratchet wrench of claim 10, wherein said wrench housing is constructed of two fixedly attached pieces to accommodate said universal pawl component, said spring assembly and a pivoting protuberance on which said universal pawl component pivotally moves.

15. The open-ended ratchet wrench of claim 14 wherein said two fixedly attached pieces are fixedly attached by at least one pin.

16. (canceled)

17. An open-ended ratchet wrench apparatus utilizing a universal pawl component comprised of:
a universal pawl component having a unitary construction which includes at least two ratchet engaging teeth and an aperture, said at least two ratchet engaging teeth are spaced so that at least one of said at least two ratchet engaging teeth is engaged with an open-ended ratchet component having a gap at all times;
a partially hollow wrench housing;
a spring assembly; and
a protuberance which pivotally engages said aperture of said universal pawl component.

18. The open-ended ratchet wrench apparatus of claim 17, wherein said wrench housing and said universal pawl component may be manufactured in varying sizes.

19. The open-ended ratchet wrench apparatus of claim 17 wherein said aperture is centered.

20. The open-ended ratchet wrench apparatus of claim 17 wherein said aperture is off-centered.

21. The open-ended ratchet wrench apparatus of claim 17 wherein said universal pawl component has a modular construction.
